(19) United States
(12) Patent Application Publication
(10) Pub. No.: US 2005/0244217 A1
(43) Pub. Date: Nov. 3, 2005

(54) Test instrument module latch system and method

(76) Inventors: William Burke, Shoreline, WA (US); Tracy Kearsley, Stanwood, WA (US)

Correspondence Address: DELLETT AND WALTERS, P. O. BOX 2786, PORTLAND, OR, 97208-2786, US

(21) Appl. No.: 10/835,869

(22) Filed: Apr. 29, 2004

(51) Int. Cl. F16D 1/00

(52) U.S. Cl. 403/321

(57) ABSTRACT

A module latching system and method provides a removable engagement between a module and a main body of an instrument, wherein removal is accomplished by depressing at least two spaced apart actuation points to disengage biased latch members between the module and main body. The module release actuation points are positioned and spaced so as to substantially simultaneously urge the module to move in a release direction as the latch members are disengaged.

### BACKGROUND OF THE INVENTION

This invention relates to test instruments, and more particularly to a latch system and method for ensuring reliable but removable engagement of a removably installable test instrument module.

Often, a test instrument may provide for optional modules to be installed in order to provide different functionality to the instrument. This raises the need for a manner to allow the modules to be easily installed or removed. However, it may be important or desirable to ensure that the module is not inadvertently removed, for example, during a testing operation. It is desired that some manner be provided to allow relatively easy insertion or removal of the module, while ensuring that the module is not too easily removed so as to result in accidental or unintentional removal.

### SUMMARY OF THE INVENTION

In accordance with the invention, a module latch system is provided with at least two independently activated latch release actuator positions in spaced relation, whereby the likelihood is low of both actuator positions being inadvertently activated in substantially simultaneous fashion.

Accordingly, it is an object of the present invention to provide an improved system for removably latching a module to a test instrument.

It is a further object of the present invention to provide an improved method of releasably engaging a removable module in a test instrument.

It is yet another object of the present invention to provide an improved test instrument that includes a removable module latching system that enables a module to be inserted and removed to the instrument, while reducing the likelihood that the module will be inadvertently removed or released.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a perspective view of a test instrument with a removable module, employing the latch system and method according to the invention;

FIG. 2 is a perspective view of the test instrument and module of FIG. 1, with the module removed from the test instrument;

FIG. 3 is an exploded perspective view of the module;

FIG. 4 is a partial cross-sectional view of one of instrument/module with the latch engaged; and

FIG. 5 is a partial cross sectional view of the instrument/module showing the latch as being disengaged.

### DETAILED DESCRIPTION

The system according to a preferred embodiment of the present invention comprises a latch system and method to allow a module to be removably but securely engaged by a test instrument. The configuration of the latch system and release mechanism is such as to reduce the likelihood of the module being inadvertently or accidentally removed from the instrument, which may be detrimental or inadvisable while the instrument is in operation or use.

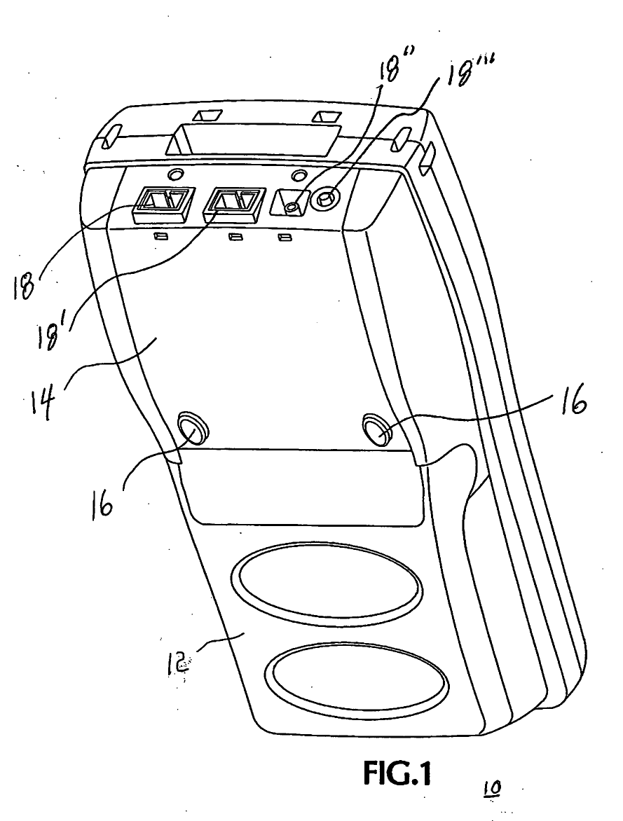

Referring now to FIG. 1, a perspective view of a test instrument with a removable module installed therein, the instrument 10, which comprises a network test instrument in a particular embodiment, includes a main body portion 12 and a removable module portion 14 which is received by the main body portion and can provide additional or optional test capabilities for the instrument. The view in FIG. 1 is of the bottom of the instrument. The module 14 has a pair of latch actuator buttons 16 in space relation to one another near left and right edges of the module body, positioned toward the rear most portion of the module (that is, the portion of the module that extends most deeply into the mail body portion). Various openings 18, 18′, 18″ and 18′″ for receiving connectors or the like are positioned at the outermost face of the module, suitable to receive network cable jacks or other connectors therein to enable interface to a network or system under test. These connectors can comprise, for example, RJ45 type connections, fiber optic connections, or other connections dependent on the type of system or network test or test functionality that the module is providing.

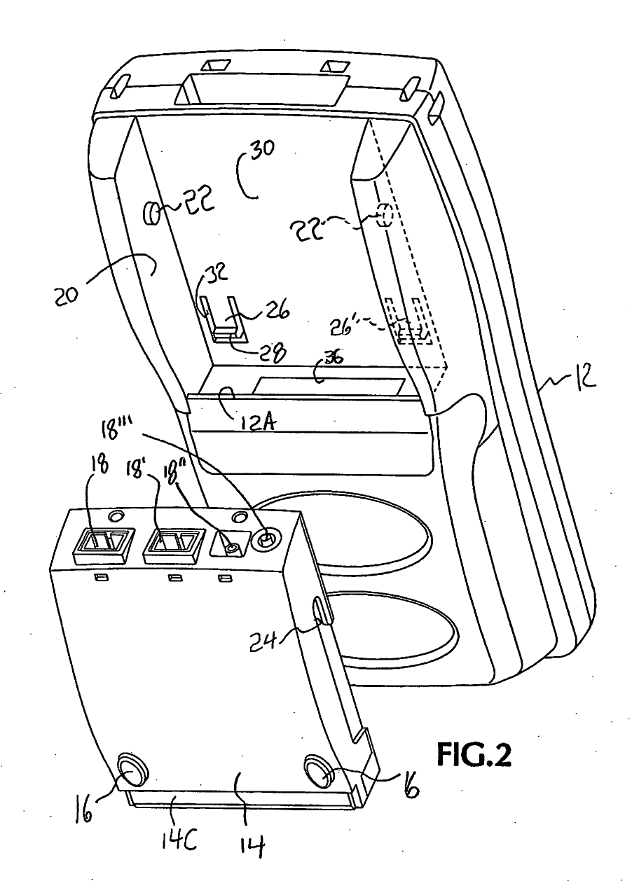

Referring to FIG. 2, which is a perspective view of the test instrument and module of FIG. 1, with the module removed from the test instrument, the main body 12 includes a defined space 20 sized and adapted to receive the module 14 therewith, and includes a pair of module engaging posts 22 at left and right side walls thereof, which are suitably engaged by corresponding slots 24 on each corresponding sides of the module 14, to secure the outer end of the module relative to the main body.

Toward the innermost end of the space 20, are a pair of latch members 26, 26′, which have a raised portion 28 which extends above the plane of the face 30 of the space 20. The latch members are flexible and biased such that the end of the latch member with raised portion 28 is capable of being depressed downwardly relative to the plane of face 30 but will return upwardly when released or when not otherwise depressed. Suitably, the latch members are defined as a portion of the same material as forming face 30, by providing cut out portions 32 along 3 sides of the latch member, leaving the 4^{th} side still attached as part of face 30. A preferred material is plastic.

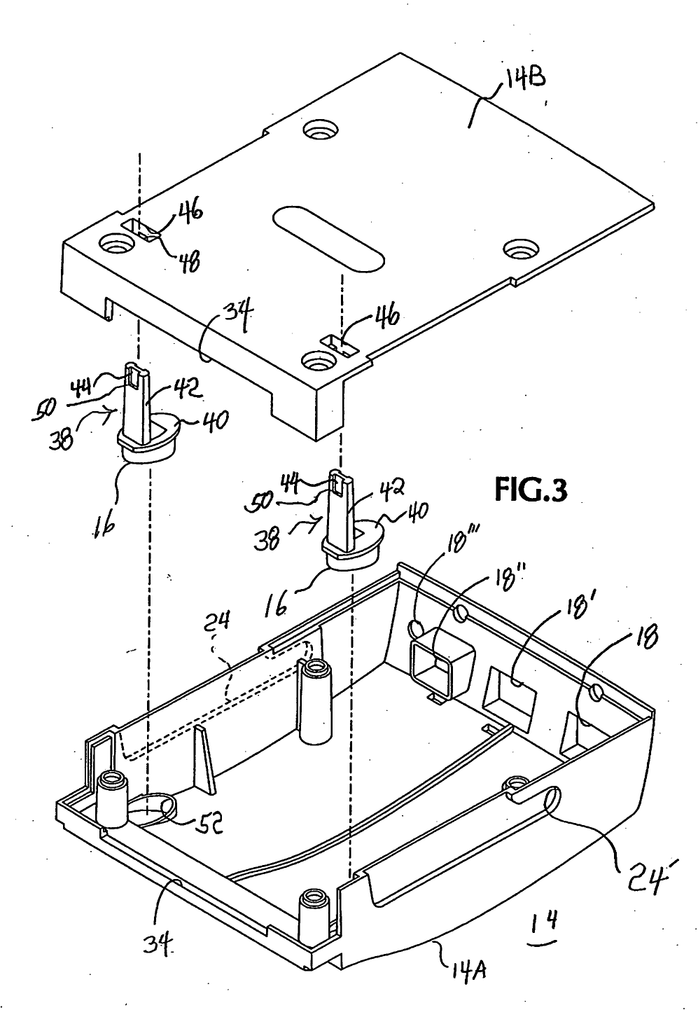

Referring now to FIG. 3, an exploded perspective view of the module as viewed from the opposite face thereof as in FIGS. 1 and 2, it may be observed that the module is suitably formed as box-like structure, being somewhat curved on the back face portion 14A thereof (relative to the view of FIG. 3). A second face portion 14B fits together with portion 14B, to form the module and may be held together with screws, for example, to enable disassembly thereof. In a test instrument configuration, the interior space of the module will hold circuitry and interface connectors to provide the functionality that the module provides to the test instrument. An opening 34 is defined by cut out portions of the module, and suitably enables a connector or jack to be accessed for engaging a corresponding jack or connector that is positioned at a correspondent opening 36 in the main body 12 (see FIG.2).

The pair of actuator buttons 16 are formed as the distal ends of latch actuators 38, comprising buttons 16, radial flange portions 40 of slightly wider diameter than the buttons 16, elongate extension portions 42 and front and rear slots 44 at the ends of portions 42 most distal from the buttons 16.

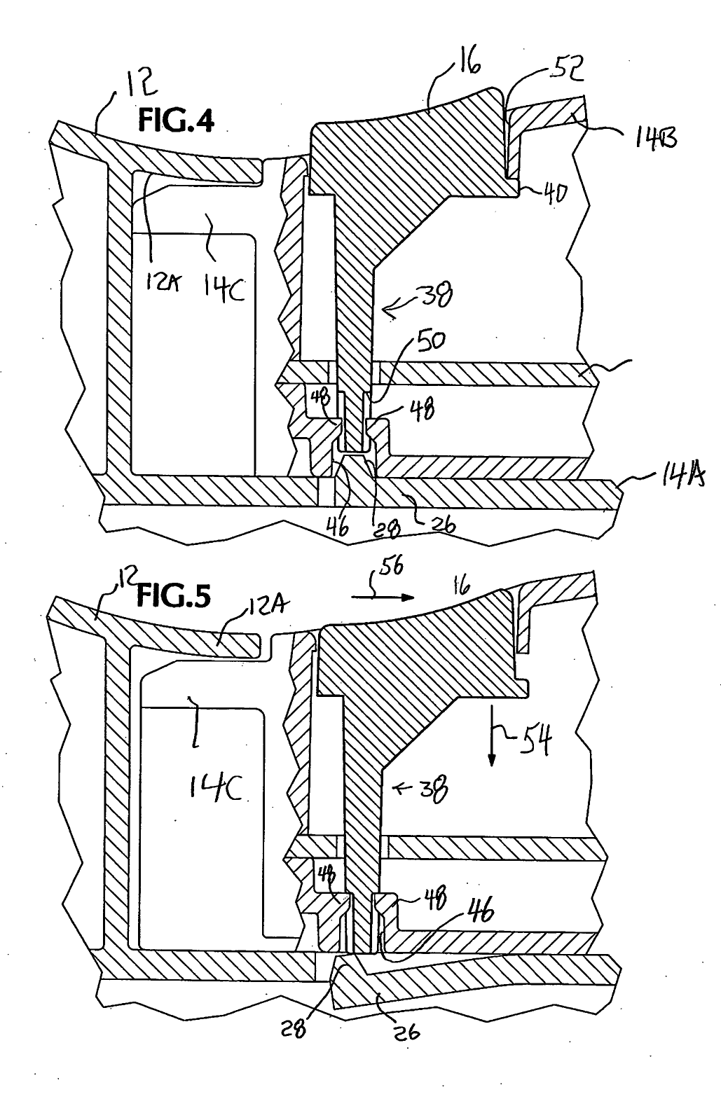

The distal ends of the portions 42 are, when the module face portions 14A and 14B are assembled, received into openings 46 in face portion 14B, the openings having corresponding members 48 that correspond with slots 44 as discussed in conjunction with FIG. 4 and FIG. 5 hereinbelow.

The buttons 16 are received through openings 52 in fact portion 14A, the openings being of a lesser diameter than the diameter of radial flanges 40, but of larger diameter than buttons 16.

Now, referring to FIG. 4, a partial cross-sectional view of one of instrument/module with the latch engaged, and to FIG. 5, the partial cross sectional view as in FIG. 4, but showing the operation of the latch being disengaged, the outer surface of the button 16 is somewhat curved, as are the faces of the module 14B and the main body 12. The wider diameter of radial flange 40 cooperates with the intermediate diameter of opening 52 to keep the latch actuator 38 from falling out of the module body via the opening 52, while the narrower diameter of the button portion 16 relative to the opening allows movement upwardly and downwardly. At the lower end (relative to the orientation of FIG. 4, of actuator 38, members 48 as defined in face 14A of the module fit within slots 44, enabling up and down movement of the actuator relative to the face 14A, but the cooperation of the members and slots result in a downward endpoint of movement being defined by the end of the slot at shoulder portion 50.

The main body 12 includes an overhanging portion 12A, while the module includes a corresponding extended portion 14C that is somewhat indented so that when the module is fully inserted into the main body, the portions 12A and 14C cooperate as is visible in FIG. 4 to provide a good fit between the module and main body. When the module is fully inserted into the main body, the raised portion 28 of the latch 26, is received by opening 46 and the upward bias (relative to the view of FIG. 4) of the latch results in the latching of the module into the main body.

In FIG. 5, the operation of releasing the latch to remove the module is shown. If the user of the instrument wishes to remove the module, the user depresses both buttons 16 in the direction of arrow 54, which causes the downward movement of the latch actuators 38 and the bottom most ends thereof pushes against the raised portions 28 of the latches to move them out of engagement with openings 46, so the module is no longer latched and can be slid out of engagement with the main body in the direction of arrow 56.

By employing two such latches in spaced relation as show in the illustrated embodiment, the user is unlikely to inadvertently remove the module from the main body, as both latch buttons 16 must be depressed at the same time in order for the module to release. Further, the somewhat curved configuration of the module and the main body in the region where they interface and the curved profile of the button faces (observable in FIGS. 4 and 5) result in the natural movement of the module in the direction of arrow 56 when the buttons are being depressed. A preferred manner of actuation the buttons is by grasping the instrument with both hands such that the bottom face thereof is facing the user, and depressing the buttons with the left and right thumbs. This enables a rather natural and ergonomic motion of pushing the module out of engagement with the main body with the same depressing motion of the thumbs.

Accordingly, an improved latch system and method is provided for enabling a removable module to be engaged by a main body of a test instrument, with features to reduce the likelihood that the module will be accidentally released from the main body. The configuration and shape gives a natural manner of releasing the latch system and removing the module from engagement.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

1. A latching system for removably engaging a removable module with a body of a test instrument, comprising:
a latch mechanism for securing the removable module to the body of the test instrument and;
a release mechanism for enabling disengagement of the module from the body of the test instrument as well as the simultaneous movement of the module from an engaged position to a removed position.

2. The latching system according to claim 1, wherein said release mechanism comprises a release actuator having at least first and second release activation positions in spaced relation to one another, whereby activation of said first and second activation positions substantially simultaneously will disengage said latch mechanism.

3. The latching system according to claim 2, wherein said activation of said first and second activation positions will move said module to a disengaged position substantially simultaneously with disengaging said latch mechanism.

4. The latching system according to claim 1, wherein said latch mechanism comprises a biased engagement member adapted to be in an engagement position in absence of external bias, and said module has a corresponding engagement portion for cooperating with said engagement member to complete a latching operation therebetween.

5. The latching system according to claim 4, wherein said release mechanism comprises a depressible member adapted for activation by a user, wherein said depressible member cooperates with and disengages said biased engagement member when depressed.

6. The latching system according to claim 5, wherein said depressible member is positioned and oriented at an angle so as to also urge movement of said module away from an engagement position when said depressible member is depressed by a user.

7. The latching system according to claim 6, wherein at least two said depressible members are provided.

8. The latching system according to claim 7, wherein at least two said depressible members are operable independently of one another.

9. A method of removably engaging a removable module with a body of a test instrument, comprising:
providing a latch mechanism for securing the removable module to the body of the test instrument and;
providing a release mechanism for enabling disengagement of the module from the body of the test instrument as well as the simultaneous movement of the module from an engaged position to a removed position.

10. The method according to claim 9, wherein said release mechanism comprises a release actuator having at least first and second release activation positions in spaced relation to one another, whereby activation of said first and second activation positions substantially simultaneously will disengage said latch mechanism.

11. The method according to claim 10, wherein said activation of said first and second activation positions will move said module to a disengaged position substantially simultaneously with disengaging said latch mechanism.

12. The method according to claim 11, wherein said latch mechanism comprises a biased engagement member adapted to be in an engagement position in absence of external bias, and said module has a corresponding engagement portion for cooperating with said engagement member to complete a latching operation therebetween.

13. The method according to claim 12, wherein said release mechanism comprises a depressible member adapted for activation by a user, wherein said depressible member cooperates with and disengages said biased engagement member when depressed.

14. The method according to claim 13, wherein said depressible member is positioned and oriented at an angle so as to also urge movement of said module away from an engagement position when said depressible member is depressed by a user.

15. The method according to claim 14, wherein at least two said depressible members are provided.

16. The method according to claim 15, wherein at least two said depressible members are operable independently of one another.
